(19) United States
(12) Patent Application Publication
(10) Pub. No.: US 2011/0125617 A1
(43) Pub. Date: May 26, 2011

(54) SYSTEM FOR MANAGING OPERATION WITH RESPECT TO STORAGE APPARATUS

(75) Inventors: Akihiko SAKAGUCHI, Tachikawa (JP); Manabu OBANA, Kawasaki (JP)

(73) Assignee: Hitachi, Ltd.

(21) Appl. No.: 12/699,718

(22) Filed: Feb. 3, 2010

(30) Foreign Application Priority Data
Nov. 26, 2009 (JP) 2009-269107

(51) Int. Cl. G06Q 50/00; G06Q 10/00; G06Q 30/00

(52) U.S. Cl. 705/30; 705/400

(57) ABSTRACT

A management system is coupled to a storage apparatus which is an apparatus for providing a logical volume, and to a billing computer which is a computer for determining a billing amount. The management system acquires an operation-related log, which is information related to an operation that is requested of the storage apparatus by a user and that has ended normally, and the management system then stores the acquired operation-related log. The management system specifies, from a plurality of operations corresponding to a plurality of operation-related logs, an invalid operation which is an operation that corresponds to a predetermined invalid operation condition which is a condition corresponding to an invalid operation, uses an operation-related log other than the operation-related log of the specified invalid operation from among the plurality of operation-related logs to perform totalization for creating billing information, which is information comprising a totalization result required for determining a billing amount, and sends the totalization information to the billing computer.

### CROSS-REFERENCE TO PRIOR APPLICATION

This application relates to and claims priority from Japanese Patent Application No. 2009-269107, filed on Nov. 26, 2009, the entire disclosure of which is incorporated herein by reference.

### BACKGROUND

The present invention generally relates to the management of a storage apparatus.

A storage apparatus, for example, that provides a logical volume (a logical storage device) in accordance with RAID (Redundant Array of Independent (or Inexpensive) Disks) based on a plurality of physical storage devices is known. As technology for managing this type of storage apparatus, for example, the technology disclosed in Japanese Patent Application Laid-open No. 2004-295464 is known. According to Japanese Patent Application Laid-open No. 2004-295464, a computer system comprises a database for managing a file attribute (a file attribute DB), a database for managing billing information (a billing information DB) and a local file system for storing file data. The billing information DB comprises a record for each combination of a user (or group) and a server. A record is added each time a new user or server is added.

### SUMMARY

Generally speaking, the amount of the charge with respect to a user who uses a logical volume is deemed to be an amount corresponding to the capacity of the logical volume that has been allocated to this user. However, in this billing method, it is conceivable that the amount of the charge is not always reasonable for a user who has not utilized the allocated logical volume very much.

Accordingly, as a new billing method, one which decides the billing amount in accordance with an operation with respect to the storage apparatus, will be considered. An operation with respect to the storage apparatus, for example, may be defined as at least one of a type of request (for example, a data copy or migration) with respect to the storage apparatus, and an amount of data that is input/output in response to this request.

However, the billing amount could also become unreasonable for the user in a case where billing is done indiscriminately for each operation with respect to the storage apparatus. This could be a case of a wasteful operation such as those cited in the examples below.
A case of an erroneous operation.
A case in which all of the data in the logical volume was backed up despite the fact that practically none of the data inside the logical volume had been updated.
A case in which data was migrated from a first logical volume to a second logical volume, but since I/O (Input/Output) performance was low, the data was returned from the second logical volume to the first logical volume.

Accordingly, an object of the present invention is to ensure that the billing amount determined in accordance with an operation with respect to the storage apparatus is as reasonable as possible for the user.

A management system is coupled to a storage apparatus which is an apparatus that provides a logical volume, and a billing computer which is a computer that determines the billing amount. The management system, for example, comprises a processor and a storage resource (for example, a memory). The management system processor acquires an operation-related log, which is information related to an operation that is requested of the storage apparatus by a user and that has ended normally, and stores the acquired operation-related log in the storage resource. The processor specifies, from a plurality of operations corresponding to a plurality of operation-related logs, an invalid operation, i.e., an operation that corresponds to a predetermined invalid operation condition, which is a condition corresponding to an invalid operation, and from among the plurality of operation-related logs, utilizes an operation-related log other than the operation-related log of the specified invalid operation to carry out totalization for creating billing information, which is information comprising the totalization result required for determining the billing amount, and sends this totalization information to the billing computer.

### BRIEF DESCRIPTION OF THE DRAWINGS

FIG. 1 shows a computer system related to an embodiment of the present invention;

FIG. 2 shows an example of the configuration of the storage apparatus;

FIG. 3 shows an example of the configuration of a host computer;

FIG. 4 shows an example of storage configuration information;

FIG. 5 shows a portion of an example of operation log information;

FIG. 6 shows an example of first operation totalization information;

FIG. 7 shows an example of second operation totalization information;

FIG. 8 is a flowchart of the processing carried out by a storage operation PG;

FIG. 9 is a flowchart of processing carried out by a storage controller;

FIG. 10 is a flowchart of processing carried out by an operation accumulation PG;

FIG. 11 is a flowchart of processing carried out by an operation totalization PG;

FIG. 12 is a flowchart of an operation check PG;

FIG. 13 shows an example of policy information;

FIG. 14 is a flowchart of processing carried out by a billing totalization PG;

FIG. 15 shows an example of a screen that displays information denoting the total operating capacity for each set of a user ID and an operation type;

FIG. 16 shows an example of a screen that displays a breakdown of the total operation capacity corresponding to a specified set; and

FIG. 17 is a diagram denoting an invalid operation and a valid operation in a case where a plurality of VOL migrations has been carried out in a cascade fashion.

### DETAILED DESCRIPTION OF THE EMBODIMENT

A number of embodiments of the present invention will be explained below by referring to the drawings.

When explaining an information element comprising various types of information, expressions such as “name” and “ID” may be used to denote identification information, but the identification information may be of any type, and each type of identification information may be interchangeable with another type of identification information.

Further, in the following explanation, there may be instances when “program” is used as the subject in explaining a process, but since a prescribed process is carried out by executing a program in accordance with the processor while using a storage resource (for example, a memory) and/or a communication control device (for example, a communication port) as needed, the processor may also be the subject of the processing. Further, processing that is explained having the program as the subject may be processing that the management system performs. Either all or a portion of the programs may be realized using dedicated hardware. For this reason, processing that is explained having the program as the subject may be processing that a controller performs. The controller may comprise a processor and a storage resource for storing the computer program executed by the processor, and may comprise the above-mentioned dedicated hardware. The computer program may be installed in the respective computers from a program source. The program source, for example, may be a program delivery server or a storage medium.

Furthermore, the management system may be one or more computers, for example, either a management computer or a combination of the management computer and a display computer. Specifically, for example, in a case where the management computer displays display information, the management computer may be the management system. Also, to increase processing speed and reliability, the same functions as those of the management computer may be realized using a plurality of computers, in which case, these plurality of computers (may include a display computer when a display computer carries out displays) may be the management system.

In the following explanation, an interface device may be abbreviated as “IF” and a computer program may be abbreviated as “PG”.

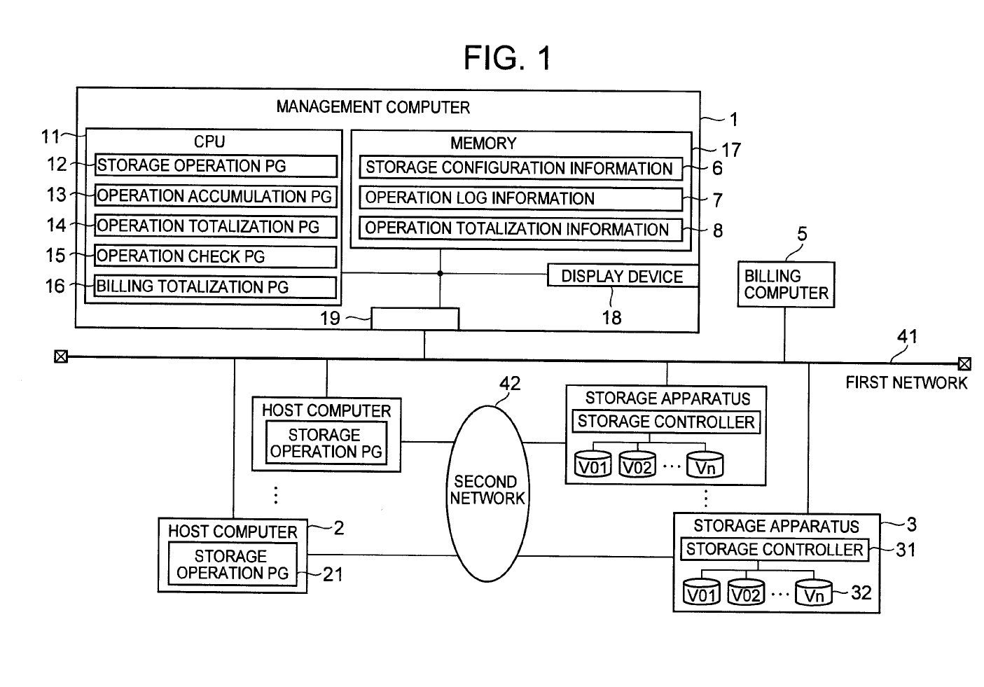

FIG. 1 shows an example of a computer system related to an embodiment of the present invention.

A plurality (or one) host computer 2, a plurality (or one) storage apparatus 3, a management computer 1, and a billing computer 5 are coupled to a first network 41. The first network 41 is a communication network (for example, a LAN (Local Area Network)), and communications are carried out over this network using a prescribed protocol, for example, the IP (Internet Protocol).

A plurality (or one) host computer 2 and a plurality (or one) storage apparatus 3 are coupled to a second network 42. The second network 42 is also a communication network (for example, a SAN (Storage Area Network)), and communications are carried out over this network using a prescribed protocol, for example, the FC (Fibre Channel) or the iSCSI (“SCSI” is the abbreviation for Small Computer System Interface).

Furthermore, the second network 42 may be integrated with the first network 41.

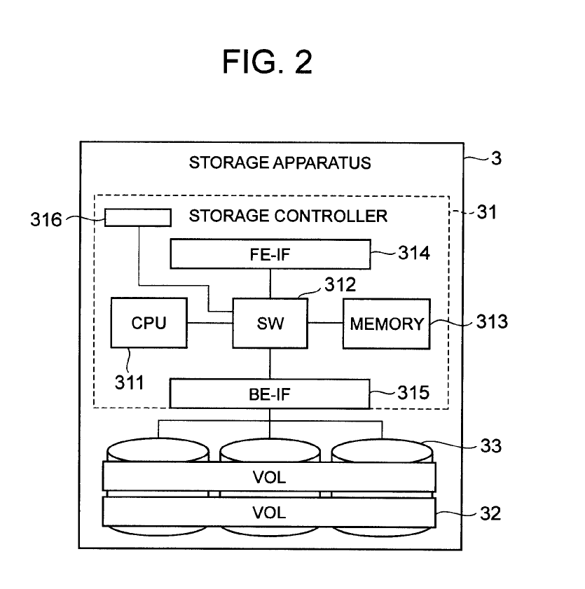

The storage apparatus 3 comprises a storage controller 31, and provides a plurality of VOLs (logical volumes) 32. Specifically, for example, as shown in FIG. 2, the storage apparatus 3 comprises a plurality of physical storage devices (for example, either HDD (Hard Disk Drives) or SSD (Solid State Drives)) 33, and provides a plurality of VOLs 32 based on this plurality of physical storage devices 33. Data stored in a VOL 32 is stored in two or more physical storage devices 33 in accordance with RAID (Redundant Array of Independent (or Inexpensive) Disks). The VOL 32 is a substantial volume created on the basis of two or more physical storage devices 33, but it is not limited thereto, and may also be a virtual volume (for example, either a capacity expansion volume in accordance with Thin Provisioning technology, or a virtual volume associated with an external logical volume that is based on an external storage).

The storage controller 31 is for receiving and processing a command from the host computer 2 and the management computer 1. This controller 31, for example, as shown in FIG. 2, comprises a FE-IF (a front-end interface device for carrying our communications over the second network 42) 314, a management IF (an interface device for carrying out communications over the first network 41) 316, a BE-IF (a back-end interface device with respect to the physical storage device 33) 315, a CPU 311 for processing a command received by either IF 314 or 316, and a switching device (SW) 312 for coupling together the above-mentioned elements 311, 313, 314, 315, and 316. A bus or other such coupling device may be used instead of the SW 312.

The CPU 311 performs processing in accordance with a command that either IF 314 or 316 has received from either computer 1 or 2. For example, in a case where a command is an I/O command (either a write or read command) received from the host computer 2, the CPU 311 carries out the I/O of data to/from the VOL 32 specified in the I/O command. In a case where the command is a migration command received from either computer 1 or 2, the CPU 311 migrates the data from the migration-source VOL specified in this command to the migration-destination VOL specified in this command. Hereinafter, the migration of data from the one VOL to the other VOL will be called a “VOL migration”. The migration-source VOL and the migration-destination VOL may exist inside a single storage apparatus 3, or may exist inside different storage apparatuses 3. The I/O of data to/from the VOL is performed via the IF 315.

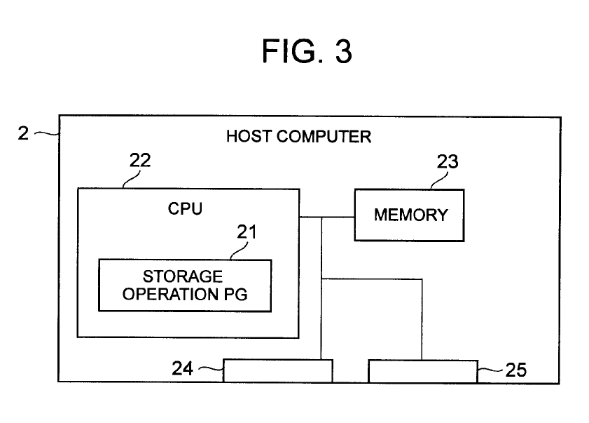

The host computer 2 issues an I/O command that specifies a VOL 32. In accordance with this, a data I/O is carried out with respect to this VOL 32. The host computer 2, for example, as shown in FIG. 3, comprises a CPU (Central Processing Unit) 22, a memory 23, a first IF (an interface device for communicating via the first network 41) 24, and a second IF (an interface device for communicating via the second network 42) 25. The memory 23 stores a computer program executed by the CPU 22. This program, for example, may be a storage operation PG 21. The storage operation PG 21 is for performing an operation with respect to the storage apparatus 3, and, for example, is a program for issuing an I/O command specifying a VOL 32.

The storage operation PG 21 sends an I/O command comprising information denoting an I/O destination to the storage apparatus 3. This information, for example, comprises a VOL 32 ID (for example, a LUN (Logical Unit Number)) and a storage area address (for example, a LBA (Logical Block Address)). Access is carried out to the storage area denoted by this information.

The management computer 1 is an example of a management system, and is a computer for managing information related to the respective host computers 2 and the respective storage apparatuses 3. The management computer 1, for example, comprises a CPU 11, a memory 17, an IF (an interface device for communicating via the first network 41) 19, and a display device 18.

The memory 17 stores storage configuration information 6, operation log information 7, and operation totalization information 8. This information will be explained in detail below, but in this embodiment, the operation totalization information 8 includes two types of information, i.e., first operation totalization information and second operation totalization information, but one of these may be eliminated. The information 6, 7, and 8 is a table structure, but may also be a structure other than the table structure.

The memory 17 also stores computer programs that are executed by the CPU 11. These programs, for example, may be a storage operation PG 12, an operation accumulation PG 13, an operation totalization PG 14, an operation check PG 15 and a billing totalization PG 16. The storage operation PG 12 performs various operations (for example, a data copy, a data compression, and a VOL migration operation) with respect to the storage apparatus 3. The storage operation PG 12 performs on operation with respect to the storage apparatus 3. The operation accumulation PG 13 constructs operation log information 7 by accumulating information related to an operation that has been performed with respect to the storage apparatus 3. The operation totalization PG 14 performs totalization based on the log information 7. The operation check PG 15 detects a wasteful operation, that is, an invalid operation that falls outside of billing, based on the information (totalization information) 8 denoting the result of totalization. The billing totalization PG 16 creates on the basis of the log information 7 totalization information for billing that does not target an invalid operation for billing, and sends this totalization information to the billing computer 5. The processing carried out by PG 12 through 16 will be explained in detail below. In this embodiment, the storage operation PG 12 is executed by the management computer 1, but the storage operation PG 12 that performs a VOL migration or copy operation with respect to the storage apparatus 3 may be executed by a computer that is different than the management computer 1, and the management computer 1 may carry out only the accumulation and totalization of information related to an operation.

The billing computer 5 is a computer (for example, a server machine) for determining the billing amount for a storage apparatus 3 user. Although not shown in the drawing, the billing computer 5 also comprises a CPU, a memory and an IF (an interface device for communicating via the first network 41). The CPU receives totalization information for billing use from the management computer 1, and determines the amounts to be billed to the respective users based on this billing totalization information.

The various types of information 6, 7 and 8 of the management computer 1 will be explained below.

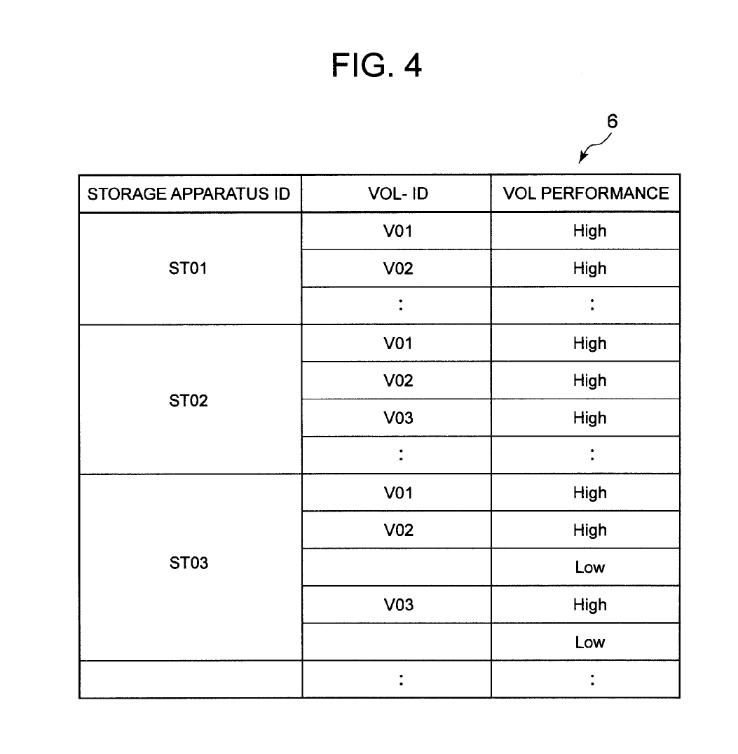

FIG. 4 shows an example of the storage configuration information 6.

The storage configuration information 6 is information denoting a configuration related to the storage apparatus 3. The storage configuration information 6, for example, comprises information denoting a storage apparatus ID, a VOL-ID, and a VOL performance for each VOL 32. The storage apparatus ID is the ID of the storage apparatus comprising the VOL 32. The VOL-ID is the ID of the VOL 32. The VOL performance is the I/O performance of the VOL 32, and, for example, depends on the I/O performance of the physical storage device 33 that provides this VOL 32. For example, “High” is set as the information denoting the VOL performance in a case where the VOL performance is equal to or greater than a predetermined value, and “Low” is set as the information denoting the VOL performance in a case where the VOL performance is less than the predetermined value.

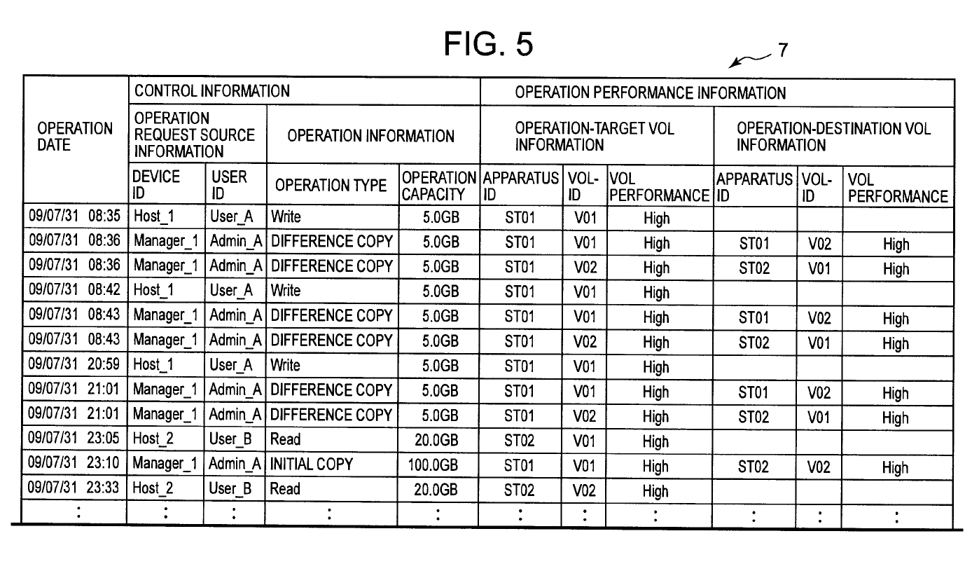

FIG. 5 shows a partial example of the operation log information 7.

The operation log information 7 shows a log of operations with respect to a management-targeted storage apparatus 3 of the management computer 1. The log information 7 comprises a log (hereinafter, the “operation-related log”) related to an operation for each such operation with respect to the storage apparatus 3. The operation-related log, for example, comprises information showing the operation date (the date on which the operation was carried out), control information, and operation performance information. The operation-related logs are lined up chronologically (for example, in either ascending or descending order of operation date) in the log information 7.

The control information comprises operation request-source information and operation information.

The operation request-source information is information related to the device that performed the operation, and, for example, comprises a device ID (the ID of the device that performed the operation with respect to the storage apparatus 3) and a user ID (the ID of the user who used the device that carried out the operation with respect to the storage apparatus 3).

The operation information is related to the details of the operation, and, for example, comprises information denoting an operation type (the type of operation), and information denoting an operation capacity.

The operation types, for example, include the following.
Write operation: A write is the writing of data to an operation-target VOL, which will be described hereinbelow.
Read operation: A read is the reading of data from the operation-target VOL.
Copy operation: A copy is the copying of data stored in the operation-target VOL to an operation-destination VOL, which will be described hereinbelow. A copy, for example, may include an initial copy and a difference copy. The initial copy is the copying of all the data stored in the operation-target VOL to the operation-destination VOL. The difference copy is the copying of only updated data (data that has been updated since the immediately previous copy) of the data stored in the operation-target VOL to the operation-destination VOL.
Compressed storage operation: Compressed storage is the compressing of data inside the operation-target VOL, and the storing of this compressed data in the operation-destination VOL (or the operation-target VOL).
VOL migration operation: A VOL migration is an operation for migrating all the data inside the operation-target VOL to the operation-destination VOL. In a VOL migration, the ID of the operation-destination VOL (the migration-destination VOL) is changed to the ID of the operation-target VOL (the migration-source VOL). For this reason, the VOL-ID of the operation-target VOL and the VOL-ID of the operation-destination VOL are the same ID for the operation type “VOL migration” in FIG. 5. However, the VOLs themselves are different. This is clear from the fact that the VOL performance for the operation type “VOL migration” differs for the operation-target VOL and the operation-destination VOL.

The operation capacity is the amount of data input/output in accordance with the operation that conforms to the specified operation type. For example, in a case where the operation type is either a write operation or a read operation, the operation capacity is the amount of data that is either written to the operation-target VOL or read from the operation-target VOL. In a case where the operation type is an initial copy, a difference copy or a VOL migration operation, the operation capacity is the amount of data written from the operation-target VOL to the operation-destination VOL. In a case where the operation type is compressed storage, the operation capacity is the amount of data (compression-targeted data) read from the operation-target VOL for compressed storage.

The operation performance information is information comprising operation-target VOL information and operation-destination VOL information.

The operation-target VOL information is related to the operation-target VOL, and, for example, comprises information denoting an apparatus ID, a VOL-ID, and a VOL performance. The “operation-target VOL” is the operational target that is specified as the VOL to which data is to be input/output. The apparatus ID is the storage apparatus that comprises the operation-target VOL, and is the apparatus on which the operation specifying the operation-target VOL is carried out. The VOL-ID is the ID of the operation-target VOL. The VOL performance is the performance of the operation-target VOL.

The operation-destination VOL information is related to the operation-destination VOL, and, for example, comprises information denoting an apparatus ID, a VOL-ID, and a VOL performance. The “operation-destination VOL” is a VOL serving as a write destination for the data that is read from the operation-target VOL, and, for example, is the VOL that is specified at compressed storage and VOL migration. The apparatus ID is the storage apparatus comprising the operation-destination VOL. The VOL-ID is the ID of the operation-destination VOL. The VOL performance is the performance of the operation-destination VOL.

The management computer 1 is able to display this operation log information 7 on the display device 18. The management computer 1 is able to display the operation log information 7 as shown in FIG. 5, and is also able to process the operation log information 7 (for example, delete a portion of the operation log information 7, or rearrange the order of the operation log information 7) and display the post-processing operation log information 7. In a case where this operation log information 7 is displayed as in FIG. 5, the information related to an operation performed further in the past is displayed first (at the top in the drawing), but in contrast to this, the information related to an operation that was performed at a date and time that is closer to the present may be displayed first.

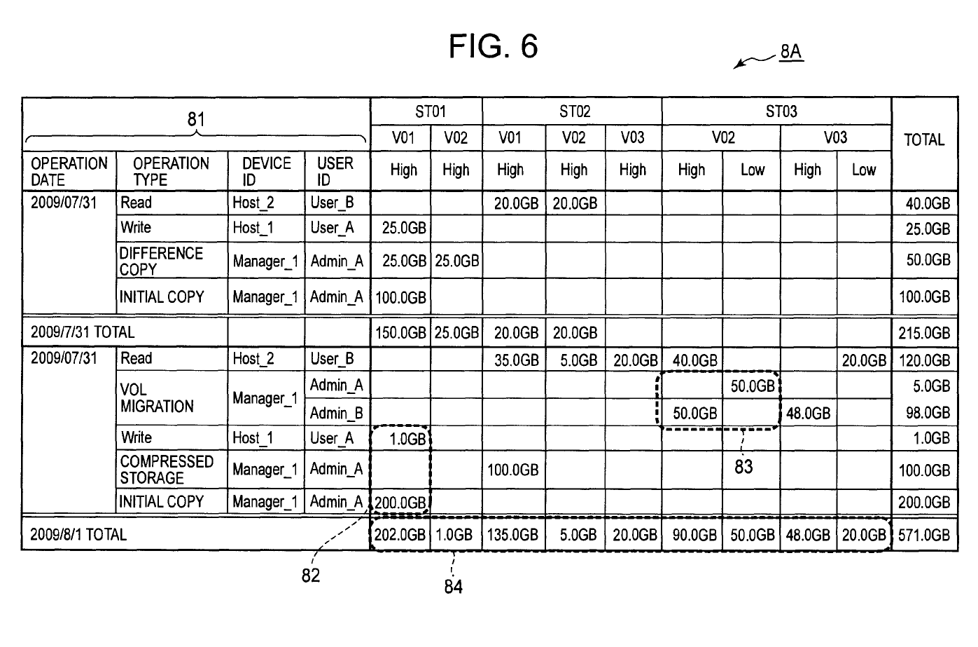

FIG. 6 shows an example of first operation totalization information 8A.

The first operation totalization information 8A is information obtained by totalizing the various information elements (values) of the operation log information 7. Specifically, according to the first operation totalization information 8A, an operation capacity is totalized for each operation-target VOL for each information set (a set of the operation date, operation type, and the device ID and user ID inside the operation request-source information) 81. For example, it is clear that the operation identified by the operation date “2009/07/31”, the operation type “Read”, the device ID “Host_2” and the user ID “User_B” is performed with respect to the VOL “V01” of the storage apparatus “ST02” and the VOL “V02” of the storage apparatus “ST02”, and that the operation capacity for each is “20 GB”.

The management computer 1 (or the user) is able to determine whether or not an invalid operation is being performed by referencing the first operation totalization information 8A.

For example, the information enclosed by the dotted line 82 shows that an initial copy was carried out to the VOL “V01” even though a write of only “1 GB” was carried out to the VOL “V01”. Since the capacity of the VOL “V01” is “200 GB”, this operation, which copied all of the VOL “V01” just for an update of “1 GB” can be seen as wasteful (In this case, performing a difference copy for copying the updated portion is considered appropriate.).

Further, for example, the information enclosed by the dotted line 83 shows that a VOL migration was carried out from the VOL “V02” with a VOL performance of “High” to the VOL “V02” with a VOL performance of “Low”, and that thereafter, a VOL migration was carried out from the VOL “V02” with a VOL performance of “Low” to the VOL “V02” with a VOL performance of “High” within a fixed time period (for example, the same day). It is conceivable, for example, that this was not considered to be a problem even though the VOL performance was low, and that a problem of some sort (for example, a task could not be performed efficiently) occurred after a VOL migration was performed to the VOL with the “Low” VOL performance. In accordance with this, the two VOL migrations carried out between the VOL with the “Low” VOL performance and the VOL with the “High” VOL performance can both be seen as wasteful.

The information enclosed by the dotted line 84 shows the total operation capacity for each VOL. The billing computer 5, for example, is able to determine the billing amount based on the total operation capacity of each VOL.

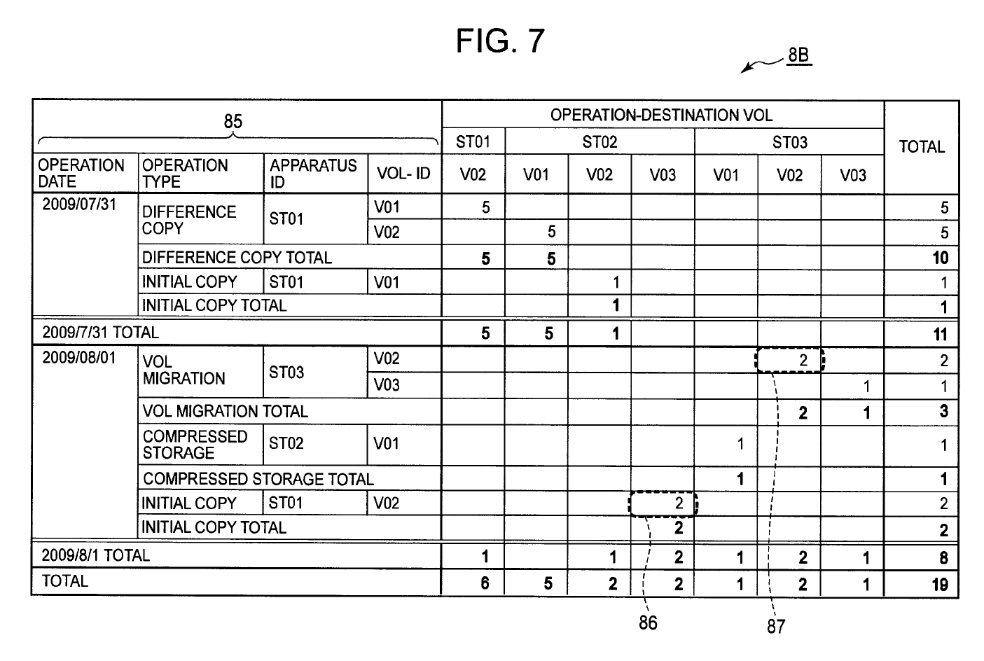

FIG. 7 is a diagram showing an example of second operation totalization information 8B.

The second operation totalization information 8B is also information obtained by totalizing the various information elements (values) of the operation log information 7 the same as the first operation totalization information 8A. Specifically, according to the second operation totalization information 8B, the number of times of operations (number of times that data was written from the operation-target VOL) is totalized for each operation-destination VOL for each information set (a set of the operation date, operation type, and the apparatus ID and VOL-ID of the operation-target VOL) 85. For example, it is clear that, on the operation date “2009/07/31”, an initial copy was carried out only one time from the operation-target VOL “V01” in the storage apparatus “ST01” to the operation-destination VOL “V02” in the storage apparatus “ST02”.

The management computer (or the user) is able to determine whether or not a wasteful operation is being carried out by referencing the second operation totalization information 8B.

For example, the information enclosed by the dotted line 86 shows that an initial copy was carried out two times on the same day from the same operation-target VOL to the same operation-destination VOL. The latter of these two operations is considered to be wasteful. This is because one initial copy per day is considered sufficient for one VOL pair (a pair comprising the operation-target VOL and the operation-destination VOL).

Further, for example, the information enclosed by the dotted line 87 shows that a VOL migration was carried out two times on the same day from the same operation-target VOL to the same operation-destination VOL. The latter of these two operations is considered to be wasteful. This is because one VOL migration per day is considered sufficient for one VOL pair (a pair comprising the operation-target VOL and the operation-destination VOL).

As described above, in this embodiment, two types of totalization, that is, the totalization of the operation capacity for each operation-target VOL for each operation request source and operation type, and the totalization of the number of times of operations for each operation-destination VOL for each operation-target VOL and operation type are carried out based on the operation log information 7. It is possible to detect a case in which a wasteful operation occurred from either one or both of these two totalization results.

The various processing carried out by this embodiment will be explained below.

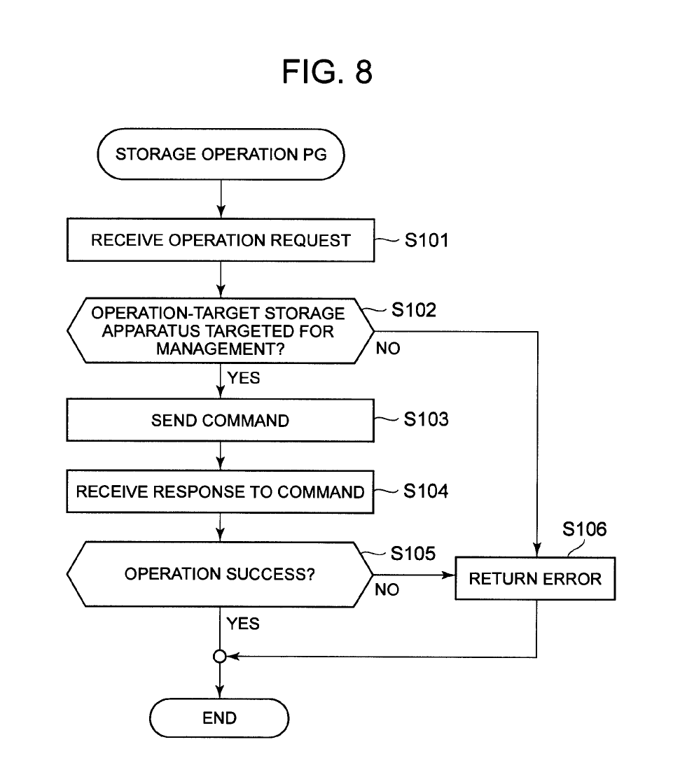

FIG. 8 is a flowchart of the processing carried out by the storage operation PG 12.

First, the storage operation PG 12 receives an operation request for the storage apparatus 3 (S101). An operation request, for example, may be a data read, a data write, a data copy, a compressed storage, and a VOL migration. The operation request, for example, comprises the ID of the operation-target storage apparatus 3 and the VOL-ID of the operation-target VOL.

Next, the storage operation PG 12 determines whether or not the VOL-ID of the operation-target VOL is included in the storage configuration information 6 (S102).

In a case where the result of the determination of S102 is negative (S102: NO), the storage operation PG 12 returns an error to the source of the operation request (for example, the user) (S106).

Alternatively, in a case where the result of the determination of S102 is affirmative (S102: YES), the storage operation PG 12 sends a command (for example, a VOL migration command in a case where a VOL migration request was received) that conforms to the operation request received in Step S101 to the storage controller 31 of the operation-target storage apparatus 3 (S103). The VOL migration command, for example, comprises the ID of the operation-target VOL, the ID of the storage apparatus 3 comprising this operation-target VOL, the ID of the operation-destination VOL, and the ID of the storage apparatus 3 comprising this operation-destination VOL.

After S103, the storage operation PG 12 receives a response to the command sent in Step S103 from the operation-target storage apparatus 3 (S104).

The storage operation PG 12 determines whether or not the operation was a success by analyzing the response received in Step S104 (S105).

In a case where the result of the determination of S105 is negative (S105: NO), the storage operation PG 12 returns an error to the source of the operation request (S106).

Alternatively, in a case where the result of the determination of S105 is affirmative (S105: YES), the storage operation PG 12 ends the processing.

Furthermore, FIG. 8 shows the flow of processing carried out by the storage operation PG 12 that is executed by the management computer 1, but the host computer 2 storage operation PG 21 is also able to carry out the same processing as in FIG. 8. The host computer 2 storage operation PG 21 may be the PG that sends the I/O command specifying the VOL, and the management computer 1 storage operation PG 12 may be the PG that sends the control command, such as the VOL migration or copy command.

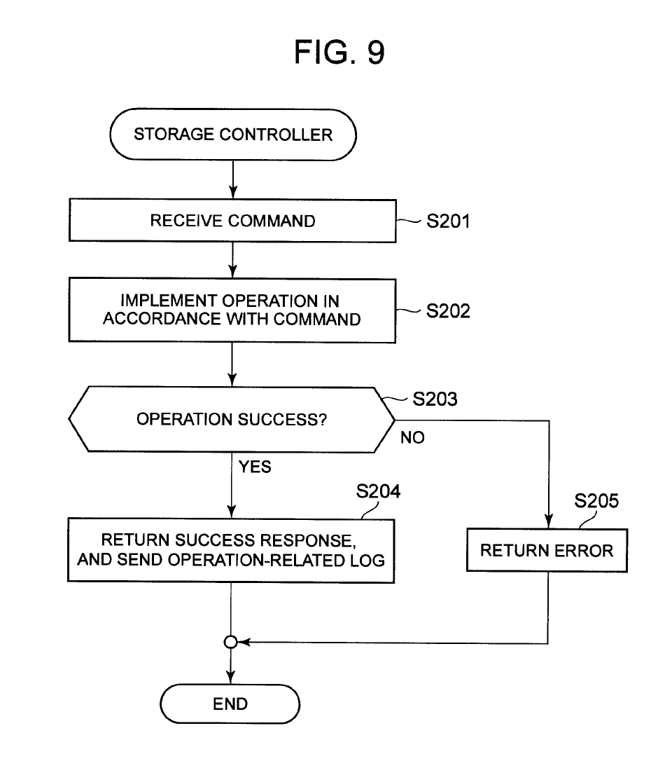

FIG. 9 is a flowchart of the processing carried out by the storage controller 31.

The storage controller 31 receives a command specifying the operation-target VOL from either storage operation PG 12 or 21 (S201).

Next, the storage controller 31 performs the operation denoted by the received command with respect to the operation-target VOL (S202).

In a case where the operation performed in Step S202 failed (S203: NO), the storage controller 31 returns an error to the source of the command, i.e., either computer 1 or 2 (S205).

In a case where the operation performed in Step S202 succeeded (S203: YES), the storage controller 31 returns a response that signifies success to the command source, and, in addition, sends a log related to the performed operation (that is, the operation-related log) to the management computer 1 (S204).

According to the processing explained using FIG. 9, the operation-related log is sent to the management computer 1 in a case where the operation was performed normally, and is not sent in the case of an error (S205). Therefore, the operation specified from the operation-related log received by the management computer 1 is not merely an operation that has been requested with respect to the storage apparatus 3, but rather, is an operation that has been performed by the storage apparatus 3.

Furthermore, instead of or in addition to the operation-related log being sent from the storage controller 31 to the management computer 1, either computer 1 or 2, whichever sent the command (requested the operation) to the storage apparatus 3, may send the operation-related log related to the requested operation in a case where a response denoting success with respect to this command has been received from the storage controller 31.

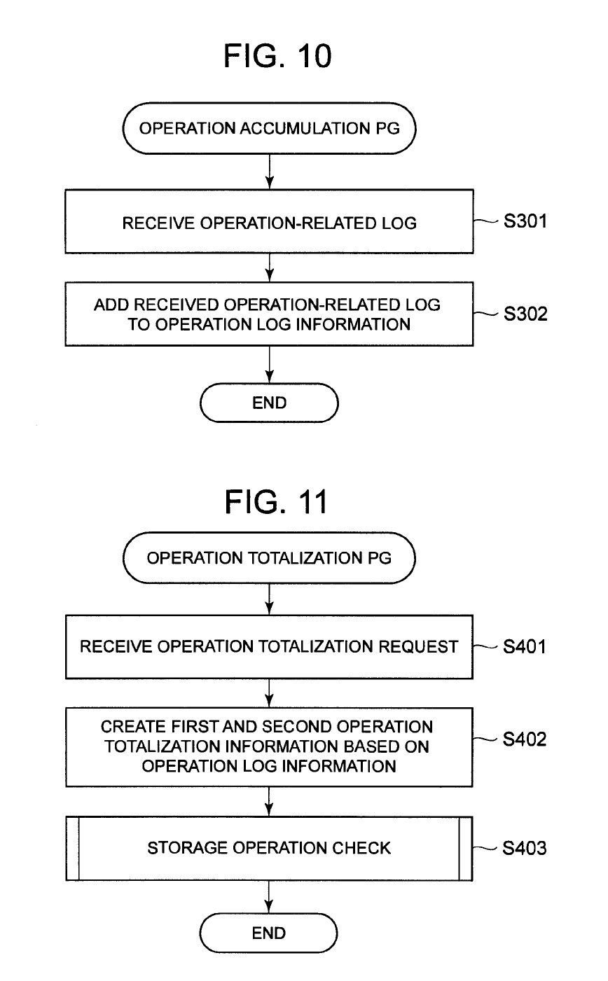

FIG. 10 is a flowchart of the processing carried out by the operation accumulation PG 13.

As explained for Step S204 of FIG. 9, the storage controller 31 sends to the management computer 1 information (an operation-related log) related to a performed operation each time an operation is performed in accordance with a command.

The operation accumulation PG 13 receives the operation-related log from the storage controller 31 (S301).

The operation accumulation PG 13 adds a log comprising this received operation-related log to the operation log information 7 (S302).

In so doing, the information related to the operation performed by the storage apparatus 3 is added to the operation log information 7 as a log.

FIG. 11 is a flowchart of the processing carried out by the operation totalization PG 14.

The operation totalization PG 14 receives an operation totalization request from the user (S401). Furthermore, instead of S401, the operation totalization PG 14 may start with S402 below on a regular basis.

The operation totalization PG 14 creates the above-mentioned first and second operation totalization information 8A and 8B by totalizing the various information elements (values) of the operation log information 7 (S402).

Then, the operation totalization PG 14 calls the operation check PG 15. In accordance with this, the storage operation check process is carried out (S403).

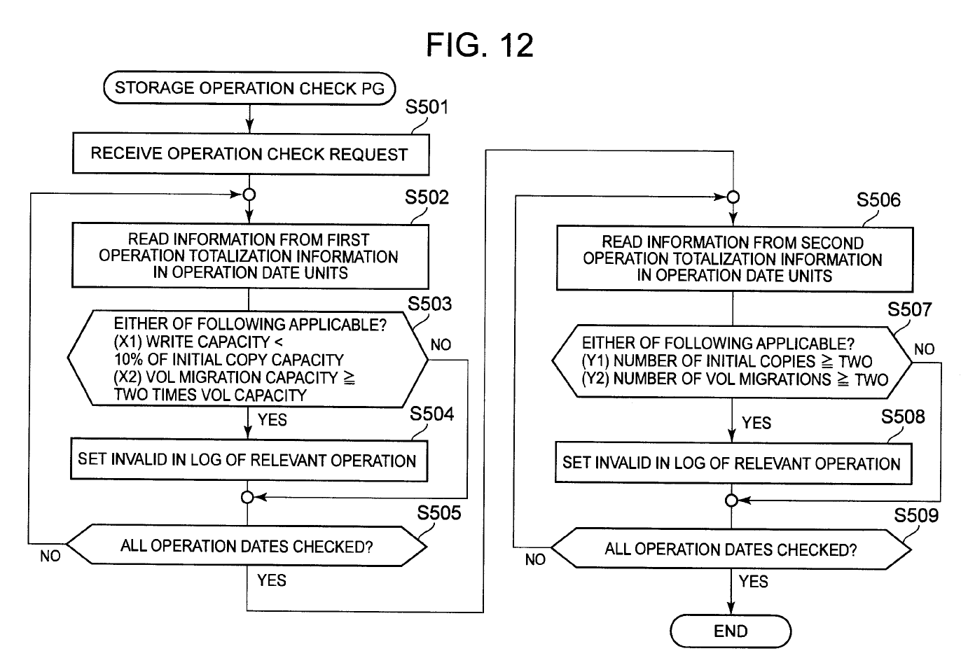

FIG. 12 is a flowchart of the storage operation check process.

The operation check PG 15 receives an operation check request from the operation totalization PG 14 (S501).

The operation check PG 15 reads information related to a certain operation date from the first totalization information 8A (S502).

The operation check PG 15 determines, from one or more logs included in the read information, whether or not there is an operation comprising a relationship corresponding to either of the following two conditions (X1) and (X2):

(X1) Write capacity<10% of initial copy capacity; and

(X2) VOL migration capacity>two times the VOL capacity (S503).

The “write capacity” in condition (X1) here is the operation capacity (the total capacity of the written data) corresponding to the operation type “write”, and the “initial copy capacity” is the operation capacity (the amount of data targeted in the initial copy) corresponding to the operation type “initial copy”. The condition (X1) conforms to a policy that states it is wasteful to perform an initial copy on a day when the amount of data written does not fill even 10% of the initial copy capacity. A different percentage may be set instead of 10%.

In the condition (X2), the “VOL migration capacity” is the operation capacity (the amount of data targeted for VOL migration) corresponding to the operation type “VOL migration”. The condition (X2) conforms to a policy that states, when the amount of data targeted for VOL migration exceeds two times the capacity of the VOL for a single day, the user is unable to perform an intended operation, and consequently carries out a second VOL migration.

In a case where the operation check PG 15 detects an operation relationship corresponding to either condition (X1) or (X2) (S503: YES), the operation check PG 15 sets invalid for the log comprising the information related to this detected operation (S504). For example, the operation check PG 15 applies a color or pattern to this log that differs from that of another log (a log related to a valid operation).

The operation check PG 15 carries out S502 through S504 for information related to all the operation dates inside the first totalization information 8A (S505).

Next, the operation check PG 15 reads information related to a certain operation date from the second totalization information 8B (S506).

The operation check PG 15 determines, from one or more logs included in the read information, whether or not there is an operation comprising a relationship corresponding to either of the following two conditions (Y1) and (Y2):

(Y1) Number of initial copies≧two; and

(Y2) Number of VOL migrations≧two (S507).

The “number of initial copies” in the condition (Y1) here is the number of times of operations (number of initial copies) corresponding to the operation type “initial copy”. The condition (Y1) conforms to a policy that states it is wasteful to carry out two or more initial copies to the same VOL pair in a day.

The “number of VOL migrations” in the condition (Y2) is the number of times of operations (number of VOL migrations) corresponding to the operation type “VOL migration”. The condition (Y2) conforms to a policy that states, in a case where a VOL migration is carried out two or more times in a day for the same VOL pair, these operations are wasteful.

In a case where the operation check PG 15 detects an operation relationship corresponding to either condition (Y1) or (Y2) (S507: YES), the operation check PG 15 sets invalid for the log comprising the information related to this detected operation (S508).

The operation check PG 15 carries out S506 and S507 for information related to all the operation dates inside the second totalization information 8B (S509).

In accordance with this storage operation check process, an operation (an operation (invalid operation) that is considered to fall outside the realm of billing) deemed as wasteful is inferred. In other words, this storage operation check process infers an operation (a valid operation) deemed as a target for billing.

The above-mentioned conditions (X1), (X2), (Y1) and (Y2), for example, are set in accordance with policy information that has been preset in the memory 17 of the management computer 1.

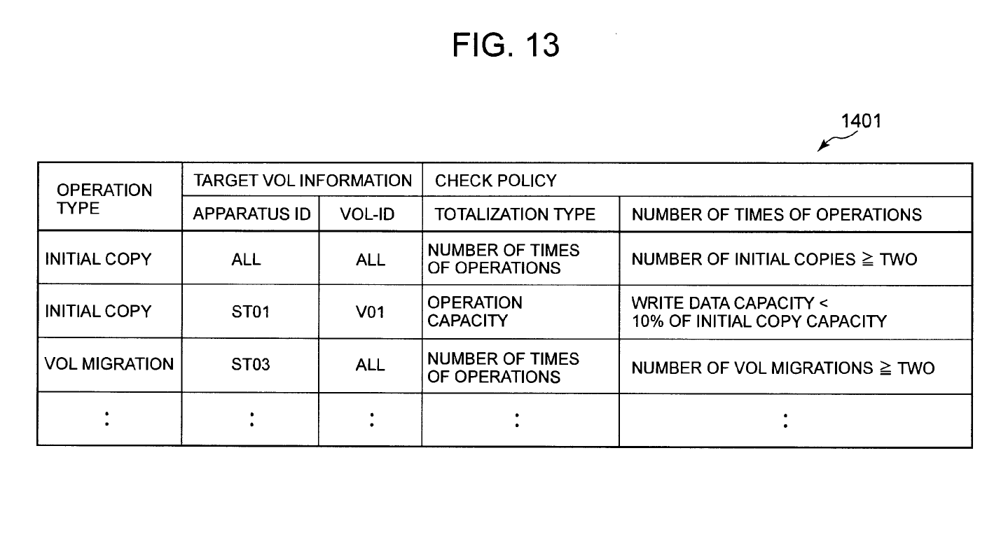

FIG. 13 shows an example of policy information 1401.

The policy information 1401 is information related to a policy for specifying an invalid operation (an invalid operation that is outside the realm of billing). Specifically, for example, the policy information 1401 comprises information denoting the operation type, information denoting the operation-target VOL, and information denoting the details of the policy for each policy.

The information denoting the operation-target VOL, for example, is configured from an apparatus ID and a VOL-ID. Furthermore, the ID “ALL” signifies the specifying of all of the storage apparatuses or VOLs.

The information denoting the details of the policy, for example, comprises information denoting a totalization type and information denoting an invalid operation condition. As totalization types, there are “operation capacity” and “number of times of operations”.

The totalization type “operation capacity” signifies that the invalid operation condition is applied to information read from the first totalization information 8A.

The totalization type “number of times of operations” signifies that the invalid operation condition is applied to information read from the second totalization information 8B.

The “invalid operation condition” is a condition for an invalid operation (a wasteful operation). The invalid operation conditions in the drawing are the above-mentioned conditions (X1), (Y1) and (Y2). The invalid operation condition, for example, may be determined by the administrator (a person other than the user, who is the target of the billing). Further, in addition to the above-mentioned elements, for example, the following user condition (p) and/or the time period condition (q) may also be associated with the invalid operation condition:

(p) Will two or more operations carried out by the same user become invalid, or will two or more operations carried out by different users become invalid?; and

(q) The time during which two or more operations were carried out (for example, a time condition, such as three hours or one day). For example, in a case where user A carries out a VOL migration from the first VOL to the second VOL, and within a certain period of time after this VOL migration has been performed, user B carries out a VOL migration from the second VOL to the first VOL, these operations may be either valid or invalid depending on the contents of (p) and/or (q). At least one condition of the above-mentioned (p) and (q) may be common to all of the invalid operation conditions. Further, the invalid operation condition may comprise a condition related to the VOL performance of the operation-target VOL and/or the operation-destination VOL.

In the storage operation check process, an invalid operation condition is applied to the type of totalization information, either BA or 8B, that corresponds to this invalid operation condition for the operation-target VOL associated with this invalid operation condition, based on the policy information 1401.

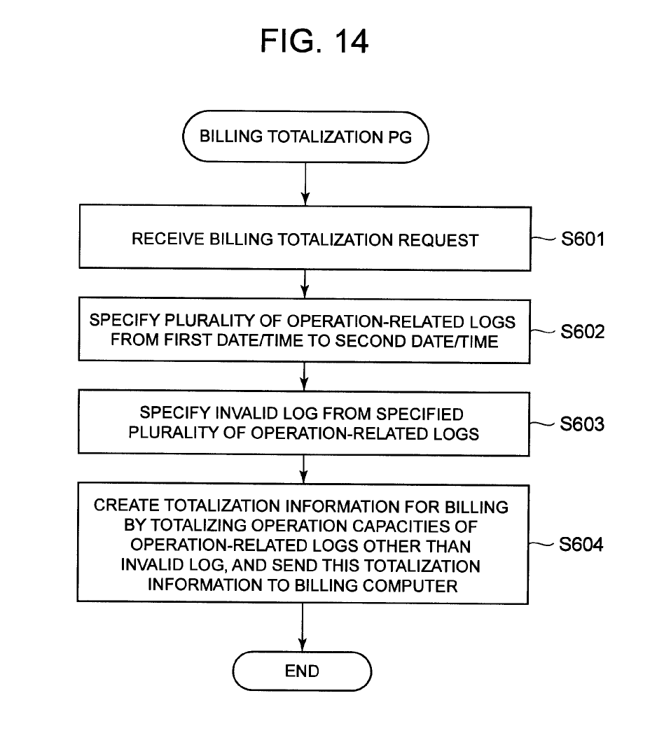

FIG. 14 is a flowchart of the processing carried out by the billing totalization PG 16.

The billing totalization PG 16, for example, receives a billing totalization request from the billing computer 5 (S601). This request may be issued from the billing computer 5, or instead of carrying out S601, the below described S602 may be started on a regular basis.

The billing totalization PG 16 specifies from the log information 7 a plurality of operation-related logs from the operation-related log recorded on a first date/time to the operation-related log recorded on a second date/time (S602). At least one of the first and second date/times may be specified by the administrator, or may be stipulated in accordance with a predetermined rule. For example, the time from the first date/time until the second date/time is the nearest preceding one day.

The billing totalization PG 16 specifies from the plurality of operation-related logs specified in S602 an operation-related log for which invalid had been set (hereinafter, the invalid log) (S603).

The billing totalization PG 16 totalizes in predetermined units the operation capacity of the operation-related log other than the invalid log specified in S603 from among the plurality of operation-related logs specified in S602, and sends information denoting the totalization result (the totalization information for billing) to the billing computer 5 via the first network 41 (S604). The totalization information for billing, for example, comprises information denoting the total operation capacity for each user.

The billing computer 5 receives the totalization information for billing. The memory of the billing computer 5, for example, stores information denoting the billing amount for a predetermined operation capacity (hereinafter, the billing amount unit information). The CPU of the billing computer 5 determines the billing amount with respect to the user based on the billing amount unit information and the total operation capacity denoted in the totalization information for billing.

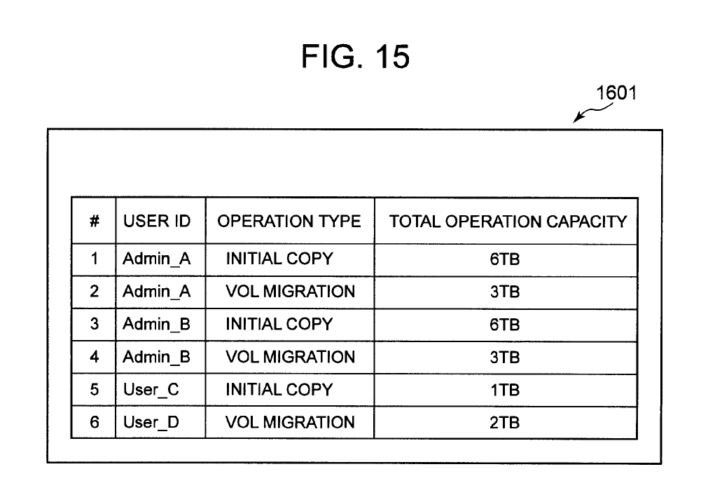

The billing totalization PG 16 is able to display the screen shown in FIG. 15 on the display device 18 based on the operation log information 7.

That is, the billing totalization PG 16 specifies on the basis of the operation log information 7 a plurality of operation-related logs from the operation-related log recorded on a first date/time to the operation-related log recorded on a second date/time, and totalizes the operation capacity of the specified logs for each set comprising the user ID and the operation type. The billing totalization PG 16 displays on the display device 16 a screen 1601 that displays information (for example, a table) denoting the total operation capacity for each user ID and operation type set.

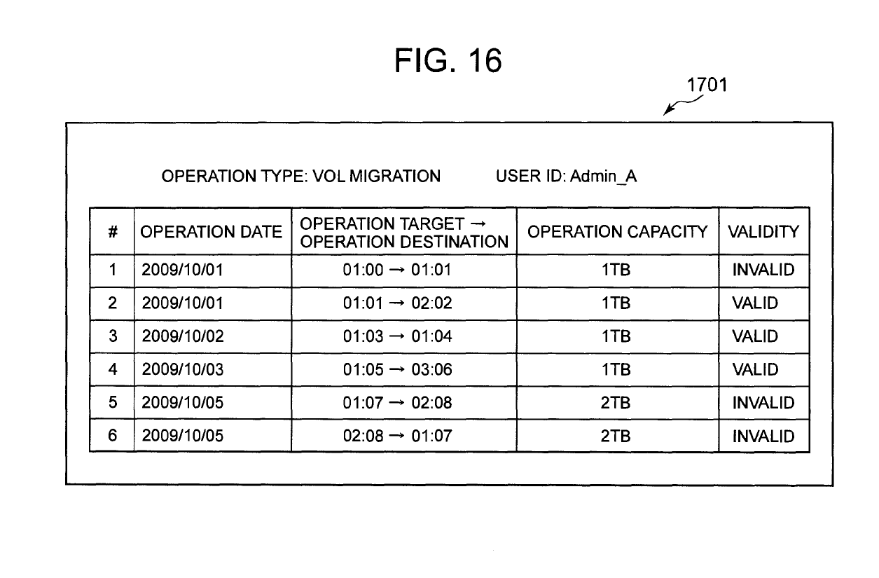

In a case where an administrator-desired set has been specified, the billing totalization PG 16 displays a screen (hereinafter, the breakdown screen) that displays a breakdown of the total operation capacity corresponding to this set. FIG. 16 shows an example of the breakdown screen.

The breakdown screen 1701 of FIG. 16 displays the breakdown of the total operation capacity corresponding to the set of the user ID “Admin_A” and the operation type “VOL migration” with respect to screen 1601 of FIG. 15. This breakdown comprises the operation capacities of all the elements of this total operation capacity, the operation date and operation content information for each operation capacity (for example, in the case of a VOL migration, information denoting from which operation-target VOL to which operation-destination VOL the data was migrated), and information denoting the valid/invalid setting for the log (operation). For example, the left half of the notation “01:00” in the screen 1701 of FIG. 16 denotes the ID of the storage apparatus, and the right half thereof denotes the ID of the VOL.

As is clear from comparing the screen 1601 of FIG. 15 to the screen 1701 of FIG. 16, the operation capacity for an operation displayed as “invalid” in the screen 1701 of FIG. 16 is not included in the total operation capacity displayed in the screen 1601 of FIG. 15. That is, the total operation capacity displayed on the screen 1601 is the total of the operation capacity of only the valid operations. The information displayed on the screen 1601 may be information created based on the first totalization information 8A. This is because the first totalization information 8A comprises information denoting the totalization result (the total operation capacity) of each set of the operation type and the user ID.

The administrator is able to look at this breakdown screen 1701 and determine the propriety of the result of the determination by the operation check PG 15. For example, according to the 5th and 6th items of information in the breakdown displayed on the screen 1701, subsequent to migrating data from the VOL “07” of the storage apparatus “01” to the VOL “08” of the storage apparatus “02”, data was migrated that same day from the VOL “08” of the storage apparatus “02” to the VOL “07” of the storage apparatus “01”. This, for example, can be considered a case in which the user, who carried out the VOL migration, was not able to achieve the intended I/O performance, and therefore returned the data to the original VOL that same day. For this reason, the determination may be made that it is correct to set invalid for both the VOL migration operation from the VOL “07” of the storage apparatus “01” to the VOL “08” of the storage apparatus “02” and the VOL migration operation from the VOL “08” of the storage apparatus “02” to the VOL “07” of the storage apparatus “01”.

In a case where the administrator finds an operation (log) for which the valid/invalid setting is determined to be incorrect, it is possible to correct the valid/invalid setting that was determined to be incorrect. The correction of the valid/invalid setting is reflected in the operation log information 7. That is, in a case where the valid/invalid setting has been corrected, the billing totalization PG 16 updates the current setting (for example, “invalid”) to the post-correction setting (for example, “valid”) with respect to the log of the operation for which the valid-invalid setting was corrected (a log inside the operation log information 7). In accordance with this, the totalization information for billing is created in the process shown in FIG. 14 based on the operation log information 7 comprising the log for which the valid/invalid setting was corrected. Therefore, it is preferable that the task of viewing the breakdown screen 1701 and correcting the valid/invalid setting be carried out prior to the processing shown in FIG. 14 being started.

According to the above-described embodiment, the information (operation-related log) related to an operation is added to the operation log information 7 every time an operation is performed with respect to the storage apparatus 3. Then, the various information elements included in this operation log information 7 are totalized in predetermined units, and in a case of a wasteful operation (invalid operation), this invalid operation is detected based on the results of this totalization (the first and second totalization information 8A and 8B). The totalization of the operation capacities targeted for billing is carried out using information, from among the operation log information 7, which excludes information related to an operation determined to be invalid. In accordance with this, the billing amount determined in accordance with an operation with respect to the storage apparatus 3 can be expected to be as reasonable an amount as possible for the user.

Furthermore, in addition to the criterion for determining a wasteful operation being based on a value of some sort as described up until this point, there may also be cases in which this criterion differs for each user. This is because, in a case where the number of copies during a specified period is used as the determination criterion, for example, if the specified period is not shortened or the number of copies is not viewed leniently, an inherently legitimate operation will be deemed a wasteful operation in a case where the access pattern with respect to the stored data changes frequently. As a measure for countering this, the management computer may be provided with an interface that enables the user to set the value (threshold) of the criterion for determining an invalid operation.

However, in a case where a charge generated by a wasteful operation is not included in the billing amount, the value of the above-mentioned determination criterion may be changed so the user can illegally reduce the billing charge. To prevent an illegal action like this, in a case where a value other than a value that is settable as the determination criterion has been set, the management computer may reject this setting.

One embodiment of the present invention has been explained hereinabove, but it goes without saying that the present invention is not limited to this embodiment, and that various changes are possible without departing from the gist thereof.

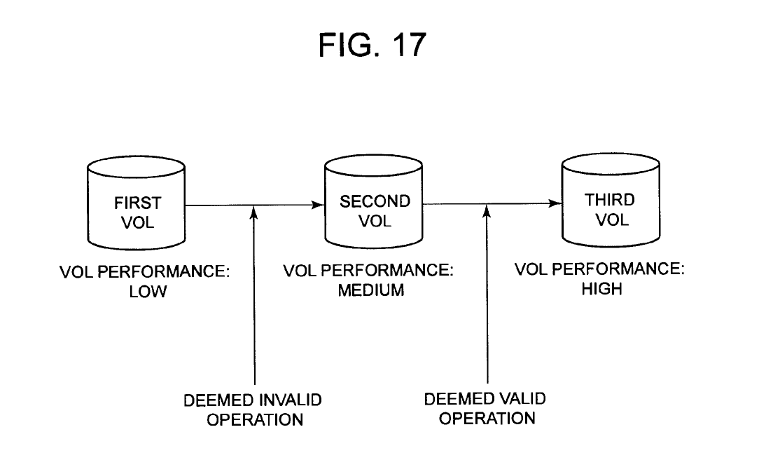

For example, a number of examples of an invalid operation (a wasteful operation) have been described hereinabove, but the following example may be used either instead of or in addition to at least one of these examples. That is, as shown in FIG. 17, in a case where a VOL migration from a first VOL (for example, a VOL with a low VOL performance) to a second VOL with VOL performance that is higher than that of the first VOL (for example, a VOI with medium VOL performance) is completed, and thereafter a VOL migration is carried out from this second VOL to a third VOL with VOL performance that is higher than that of the second VOL (for example, a VOL with high VOL performance) within a predetermined period (for example, the same day), one of these VOL migration operations may be determined as being valid, and the remaining operations may be determined as being invalid. In other words, an invalid operation condition that states “In a case where a plurality of VOL migrations are carried out in a cascade fashion within a predetermined period, only the operation that was carried out lastly from among these plurality of VOL migration operations is deemed a valid operation, and the remainder are invalid operations” may be set. This is because, in this case, the user's intention is believed to be the migration of data to a VOL that has a higher VOL performance, and it is possible to determine that the VOL other than the final migration-destination VOL did not provide the VOL performance sought by the user.

Thus, there are a variety of operations that are carried out with respect to the storage apparatus 3, and therefore, there are also a variety of operations that are considered to be invalid in accordance with at least one of the operation type, the operation-target VOL and the operation-destination VOL. The operation check PG 15 is able to detect numerous types of invalid operations in accordance with the administrator setting as many invalid operation conditions as are conceivable in the management computer 1 in accordance with at least one of the operation type, the operation-target VOL and the operation-destination VOL.

Further, according to the above-described embodiment, the valid/invalid check result for an operation is used in determining the billing amount, but this check result may also be used in another service either instead of or in addition to this. As another service, for example, one that provides the user with a proposal for improving operations is conceivable. Specifically, for example, in a case where an invalid operation (a wasteful operation) is detected based on the information denoting the result of a totalization performed based on the operation log information 7, the operation check PG 15 may notify the user that carried out this operation (the user who requested this operation) of the information denoting the invalid operation. More specifically, for example, this process is as follows.

In a case where the user has set the storage apparatus 3 to regularly back up (copy) the data inside a certain VOL (hereinafter, described as “VOL-T” for the sake of convenience), the data inside this VOL-T is backed up on a regular basis. However, in a case where the data inside this VOL is being backed up despite the fact that data is not being written to the VOL-T, the backup is wasteful. Accordingly, in a case where the operation check PG 15 is unable to detect that data larger than a predetermined quantity K (K being a value of 0 or greater) has been written to the VOL-T within a fixed period from the first totalization information 8A based on the operation log information 7, the operation check PG 15 may provide the user who carried out the operation related to the backup of the data from the VOL-T with information denoting advice for improving operations (for example, reduce the backup frequency or do not perform a backup).

A management system that carries out a service other than the determination of the billing amount, for example, may be described as follows.

### <Description>

A management system comprising:

an interface that is coupled to a storage apparatus, which provides a logical volume;

a storage resource; and

a processor that is coupled to the interface and the storage resource,

wherein the processor:

(s1) acquires an operation-related log, which is information related to an operation that is requested of the storage apparatus by a user and that has ended normally;

(s2) stores the operation-related log acquired in the (s1) in the storage resource;

(s3) specifies, from a plurality of operations corresponding to a plurality of operation-related logs stored in the storage resource, an invalid operation which is an operation corresponding to a predetermined invalid operation condition which is a condition corresponding to an invalid operation; and

(s4) performs information processing using the operation-related log of the specified invalid operation (for example, issues a notification to the computer being used by the user that performed this invalid operation), or carries out information processing using an operation-related log other than the operation-related log of the specified invalid operation.

Furthermore, the above explanation focused on a volume (a logical volume) as the operation target, but the present invention is not limited to this. In particular, either a data migration or a copy may target a data area inside a volume (for example, in units of 10GB, or a variable length data area) that is other than a volume unit. Needless to say, the detailed operation is capable of being understood by replacing the term “volume” in the explanation up to this point with the expression “data area” when explaining the operation target.

What is claimed is:

1. A management system comprising:
an interface coupled to a storage apparatus which is an apparatus for providing a logical volume, and to a billing computer which is a computer for determining a billing amount;
a storage resource; and
a processor coupled to the interface and the storage resource,
wherein the processor:
(A) acquires an operation-related log, which is information related to an operation that is requested of the storage apparatus by a user and that has ended normally,
(B) stores the operation-related log acquired in the (A) in the storage resource,
(C) specifies, from a plurality of operations that correspond to a plurality of operation-related logs stored in the storage resource, an invalid operation which is an operation corresponding to a predetermined invalid operation condition which is a condition corresponding to an invalid operation,
(D) uses an operation-related log other than the operation-related log of the specified invalid operation from among the plurality of operation-related logs that are stored in the storage resource, to carry out totalization for creating billing information, which is information comprising a totalization result required to determine a billing amount, and
(E) sends the billing information to the billing computer, which uses the billing information to determine a billing amount.

2. A management system according to claim 1,
wherein the operation-related log comprises:
information denoting an operation date/time, which is the date/time at which an operation is carried out with respect to the storage apparatus:
information denoting the type of this operation, information denoting an operation-target VOL, which is a logical volume that is the target of this operation: and
information denoting an operation capacity, which is the quantity of data input/output to/from the operation-target VOL,
wherein the invalid operation condition comprises a condition related to an operation type and an operation capacity, and
wherein, in the (C), the processor:
(c1) totalizes the operation capacities specified from the plurality of operation-related logs for each operation-target VOL specified from the respective operation-related logs based on an operation date/time specified from the respective operation-related logs: and
(c2) specifies, based on the totalization result in the (c1), an operation which is carried out within a fixed time period, and which corresponds to the invalid operation condition.

3. A management system according to claim 2,
wherein the operation-related log further comprises information identifying the user who has carried out the operation with respect to the storage apparatus,
wherein, in the (c1), the processor totalizes the operation capacities specified from the plurality of operation-related logs for each set of an operation-target VOL and user identification information specified from the respective operation-related logs based on an operation date/time specified from the respective operation-related logs, and
wherein, in the (c2), the processor specifies, based on the totalization result in the (c1), an operation which is carried out by the same user within a fixed time period, and which corresponds to the invalid operation condition.

4. A management system according to claim 3,
wherein the operation type includes a type in which data read from the operation-target VOL is written to an operation-destination VOL, which is a different VOL,
wherein the operation-related log further comprises information denoting the operation-destination VOL,
wherein the invalid operation condition comprises a condition related to the number of times that an operation in which data is read from the same operation-target VOL and written to the same operation-destination VOL is carried out,
wherein, in the (c1), the processor also totalizes, based on the plurality of operation-related logs, the number of times that an operation in which data is read from the same operation-target VOL and written to the same operation-destination VOL is carried out, and
wherein, in the (c2), the processor specifies, based on the result of totalizing the number of times of operations, an operation which is carried out the number of times corresponding to the invalid operation condition within a fixed time period, and in which data is read from the same operation-target VOL and written to the same operation-destination VOL.

5. A management system according to claim 4, wherein the operation type in which data is read from the operation-target VOL and written to the operation-destination VOL is either a migration or a copy of data from the operation-target VOL to the operation-destination VOL.

6. A management system according to claim 1, wherein the processor:
(X) displays information related to a plurality of operations denoted by the plurality of operation-related logs so that a valid operation and an invalid operation can be distinguished.

7. A management system according to claim 1,
wherein the operation-related log comprises:
information denoting an operation date/time, which is the date/time at which an operation is carried out with respect to the storage apparatus:
information denoting this operation type:
information denoting an operation-target VOL, which is a logical volume that is the target of this operation: and
information denoting an operation-destination VOL, which is the write destination of data that is read from the operation-target VOL in accordance with this operation,
wherein the invalid operation condition comprises a condition related to an operation type, and the number of times that an operation in which data is read from the same operation-target VOL and written to the same operation-destination VOL is carried out, and
wherein, in the (C), the processor:
(c1) totalizes, based on the plurality of operation-related logs, the number of times that an operation in which data is read from the same operation-target VOL and written to the same operation-destination VOL is carried out: and
(c2) specifies, based on the result of totalizing the number of times of operations, an operation which is carried out the number of times corresponding to the invalid operation condition within a fixed time period, and in which data is read from the same operation-target VOL and written to the same operation-destination VOL.

8. A management system according to claim 7, wherein the operation type in which data is read from the operation-target VOL and written to the operation-destination VOL is either a migration or a copy of data from the operation-target VOL to the operation-destination VOL.

9. A management system according to claim 8,
wherein the operation type in which data is read from the operation-target VOL and written to the operation-destination VOL is a migration of data from the operation-target VOL to the operation-destination VOL, and
wherein the invalid operation condition is a condition signifying that, in a case where a first migration operation for migrating data from the operation-target VOL to the operation-destination VOL is carried out, and thereafter a second migration operation for returning the data from the operation-destination VOL to the original operation-target VOL is carried out within a fixed time period, both the first and the second migration operations are invalid operations.

10. A management system according to claim 8,
wherein the operation type in which data is read from the operation-target VOL and written to the operation-destination VOL is a VOL migration in which data is migrated from the operation-target VOL to the operation-destination VOL, and
wherein the invalid operation condition is a condition signifying that, in a case where a plurality of VOL migration operations are carried out such that data is moved between a plurality of VOLS in a cascade fashion, the final operation is valid, and operations other than this final operation are invalid operations.

11. A billing support method realized by a computer system that comprises a storage apparatus which is an apparatus for providing a logical volume, a billing computer which is a computer for determining a billing amount, and a management system coupled to the storage apparatus and the billing computer, the method comprising the steps of:
(A) the management system acquiring an operation-related log, which is information related to an operation that is requested of the storage apparatus by a user and that has ended normally;
(B) the management system storing the operation-related log acquired in the (A);
(C) the management system specifying, from a plurality of operations that correspond to a plurality of operation-related logs, an invalid operation which is an operation corresponding to a predetermined invalid operation condition which is a condition corresponding to an invalid operation;
(D) the management system using an operation-related log other than the operation-related log of the specified invalid operation from among the plurality of operation-related logs, to carry out totalization for creating billing information, which is information comprising a totalization result required to determine a billing amount; and
(E) the management system sending the billing information to the billing computer, which uses the billing information to determine a billing amount.
